(19) United States
(12) Patent Application Publication
(10) Pub. No.: US 2010/0110331 A1
(43) Pub. Date: May 6, 2010

(54) OPTICAL FILM, BACKLIGHT UNIT, AND LIQUID CRYSTAL DISPLAY

(76) Inventors: Byeongheui Han, Cheongju-si (KR); Seoungho Lee, Cheongju-si (KR); Kieon Eom, Cheongju-si (KR)

Correspondence Address: KED & ASSOCIATES, LLP, P.O. Box 221200, Chantilly, VA, 20153-1200, US

(21) Appl. No.: 12/482,760

(22) Filed: Jun. 11, 2009

(30) Foreign Application Priority Data
Nov. 6, 2008 (KR) 10-2008-0109909
Nov. 19, 2008 (KR) 10-2008-0115000

(51) Int. Cl. G02F 1/13357; G02B 27/10

(52) U.S. Cl. 349/62; 359/619

(57) ABSTRACT

An optical film, a backlight unit including the optical film, and a liquid crystal display including the backlight unit are provided. The optical film includes a base and a projection including a plurality of microlenses and a plurality of grooves positioned around the plurality of microlenses.

This application claims the benefit of Korean Patent Application No. 10-2008-0109909 filed on Nov. 6, 2008 and No. 10-2008-0115000 filed on Nov. 19, 2008 the entire contents of which is incorporated by reference.

### BACKGROUND

1. Field

Embodiments of the invention relate to an optical film, a backlight unit including the optical film, and a liquid crystal display including the backlight unit.

2. Description of the Related Art

A display field visually displays information of various electrical signals. In the display field, various kinds of flat panel displays having excellent characteristics such as thin profile, lightness in weight, and low power consumption have been introduced. Additionally, flat panel displays are replacing cathode ray tubes (CRT).

Examples of flat panel displays include a liquid crystal display (LCD), a plasma display panel (PDP), a field emission display (FED), and an electroluminescence display (ELD). The liquid crystal display is used as a display panel of notebooks, monitors of personal computers, and TV monitors because of a high contrast ratio and excellent display characteristics of a moving picture.

The liquid crystal display is considered as a light receiving display. The liquid crystal display includes a liquid crystal display panel that displays an image and a backlight unit that is positioned under the liquid crystal display panel to provide the liquid crystal display panel with light.

The backlight unit includes a light source and an optical sheet. The optical sheet includes a diffusion sheet, a prism, or a protective sheet. In the backlight unit, the optical sheet including a plurality of sheets may be used to diffuse and focus light produced by the light source. However, there may be limits to improvement in fabrication yield and improvement in a luminance of the backlight unit.

### SUMMARY

Embodiments of the invention provide an optical film capable of improving a luminance and preventing generation of a bright line, a backlight unit including the optical film, and a liquid crystal display including the backlight unit.

In one aspect, there is an optical film comprising a base and a projection including a plurality of microlenses and a plurality of grooves positioned around the plurality of microlenses.

In another aspect, there is a back light unit comprising a light source and an optical film on the light source, the optical film including a base and a projection including a plurality of microlenses, a plurality of grooves positioned around the plurality of microlenses, and a remaining portion excluding the microlenses and the grooves from the projection, wherein a relationship P: 2W1+W2 between the microlenses, the grooves, and the remaining portion is approximately 25:1 to 25:15, where P is a pitch of the microlenses, W1 is a width of one of the grooves inside the pitch P of the microlenses, and W2 is a width of the remaining portion inside the pitch P of the microlenses.

In still another aspect, there is a liquid crystal display comprising a light source, an optical film on the light source, the optical film including a base and a projection including a plurality of microlenses, a plurality of grooves positioned around the plurality of microlenses, and a remaining portion excluding the microlenses and the grooves from the projection, wherein a relationship P: 2W1+W2 between the microlenses, the grooves, and the remaining portion is approximately 25:1 to 25:15, where P is a pitch of the microlenses, W1 is a width of one of the grooves inside the pitch P of the microlenses, and W2 is a width of the remaining portion inside the pitch P of the microlenses, and a liquid crystal display panel on the optical film.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an exemplary method of manufacturing an optical film according to an embodiment of the invention;

FIGS. 2 to 5 illustrate an optical film according to a first exemplary embodiment of the invention;

FIGS. 6 and 7 illustrate an optical film according to a second exemplary embodiment of the invention;

FIGS. 8 and 9 illustrate an optical film according to a third exemplary embodiment of the invention;

FIGS. 10 and 11 illustrate an optical film according to a fourth exemplary embodiment of the invention;

FIGS. 12 and 13 illustrate various structures of an optical film according to embodiments of the invention;

FIGS. 14 and 15 illustrate an exemplary configuration of a backlight unit according to an embodiment of the invention;

FIGS. 16 and 17 illustrate another exemplary configuration of a backlight unit according to an embodiment of the invention; and

FIGS. 18 and 19 illustrate an exemplary structure of a liquid crystal display according to an embodiment of the invention.

### DETAILED DESCRIPTION OF THE EMBODIMENTS

Reference will now be made in detail embodiments of the invention examples of which are illustrated in the accompanying drawings.

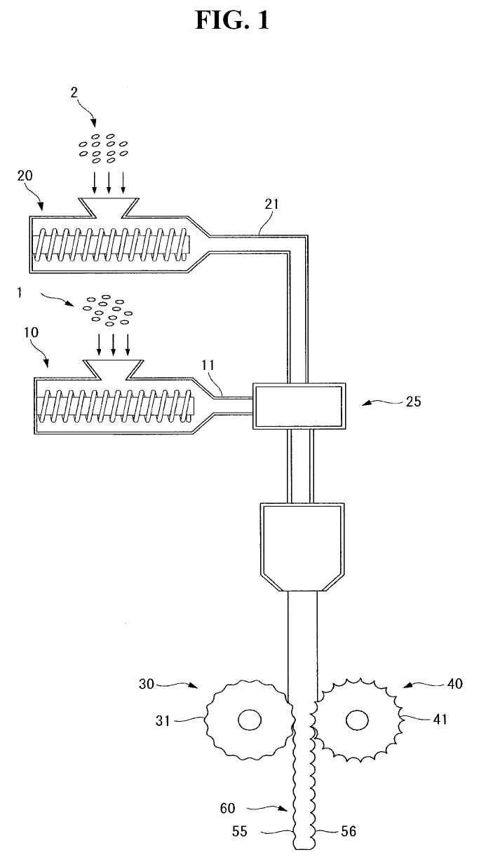

FIG. 1 illustrates an exemplary method of manufacturing an optical film according to an embodiment of the invention.

As shown in FIG. 1, a first resin 1 and a second resin 2 are coextruded. More specifically, an extrusion process is simultaneously performed on the first and second resins 1 and 2 by providing the first resin 1 to a first extruder 10 and providing the second resin 2 to a second extruder 20.

A material of the first and second resins 1 and 2 may use polystyrene (PS), polyacrylate (PA), polymethylmethacrylate (PMMA), polycarbonate (PC), or polyethyleneterephthalate (PET). Other materials may be used. It may be preferable to use polycarbonate having a refractive index of 1.58 in consideration of optical application.

Each of the first and second resins 1 and 2 may use polycarbonate pellets. The pellets may be solidified particles of a predetermined material. Namely, the pellets may be not powders but large-sized particles. The pellets may be formed by mixing each of the first and second resins 1 and 2 with an additive such as an antioxidant and an UV additive.

Each of the first and second resins 1 and 2 may include diffusion particles. When the first and second resins 1 and 2 including the diffusion particles are used to manufacture an optical film, the first and second resins 1 and 2 may contribute to light diffusion of the optical film.

If the first and second resins 1 and 2 do not include the diffusion particles, an optical film according to a first exemplary embodiment of the invention described later may be manufactured. If the first and second resins 1 and 2 include the diffusion particles, an optical film according to a second exemplary embodiment of the invention described later may be manufactured. If only the first resin 1 includes the diffusion particles, an optical film according to a third exemplary embodiment of the invention described later may be manufactured.

The diffusion particles may be formed of at least one selected from the group consisting of silicon, polymethylmethacrylate (PMMA), and polycarbonate (PC). The diffusion particles may have a diameter of approximately 1 μm to 20 μm. Other materials and diameters may be used.

An inner temperate of each of the first and second extruders 10 and 20 is approximately 280 to 300° C. Therefore, if resin pellets are provided to each of the first and second extruders 10 and 20, the resin pellets are melted inside the first and second extruders 10 and 20, and then the first and second resins 1 and 2 are discharged through extrusion pipes 11 and 21 of the first and second extruders 10 and 20.

The coextruded first and second resins 1 and 2 are simultaneously rolled using a first roll 30 having a first structured surface 31 and a second roll 40 having a second structured surface 41 to form an optical film 60 including a base 55 having a curved surface and a projection 56.

More specifically, if the first and second resins 1 and 2 are extruded respectively through the extrusion pipes 11 and 21, the first and second resins 1 and 2 are together extruded.

A surface temperature of each of the first and second rolls 30 and 40 is kept at approximately 90 to 100° C. The first and second resins 1 and 2 rolled between the first and second rolls 30 and 40 may be rapidly cooled and solidified.

The coextruded first and second resins 1 and 2 pass between the first and second rolls 30 and 40 and are rolled, and thus the optical film 60 including the base 55 and the projection 56 may be manufactured.

The first structured surface 31 of the first roll 30 may have a meandering wave pattern, and the second structured surface 41 of the second roll 40 may have a reversed shape of the microlens.

The surface of the second roll 40 may be coated with nickel (Ni) and then ceramic, and then the coated surface of the second roll 40 is processed using a laser to form the second structured surface 41 of the second roll 40. More specifically, if a laser beam is irradiated to the surface of the second roll 40, ceramic in a portion of the second roll 40, to which the laser beam is irradiated, is melted and flows laterally. Hence, the surface of the second roll 40 has a reversed shape of the microlens. Because a melted form of ceramic remains in the surface of the second roll 40, the microlens may have a predetermined surface roughness when the microlens is manufactured using the second roll 40 in a subsequent process. Hence, the optical film 60 rolled by the first and second rolls 30 and 40 may include a plurality of microlenses, the projection 56 having grooves positioned around the plurality of microlenses, and the base 55 having the curved surface.

One surface of the optical film 60 has a reversed shape of the first structured surface 31 of the first roll 30 and has a curved surface of a meandering wave pattern. Another surface of the optical film 60 has a reversed shape of the second structured surface 41 of the second roll 40 and has the microlens-shaped projection 56. Accordingly, the optical film 60 including the base 55, of which a lower surface is the curved surface, and the projection 56 may be formed.

On the other hand, the first structured surface 31 of the first roll 30 may be a flat surface. Hence, the one surface of the optical film 60 may be a flat surface.

Hereinafter, optical films manufactured by the exemplary method of manufacturing the optical film according to the embodiment of the invention illustrated in FIG. 1 are described later.

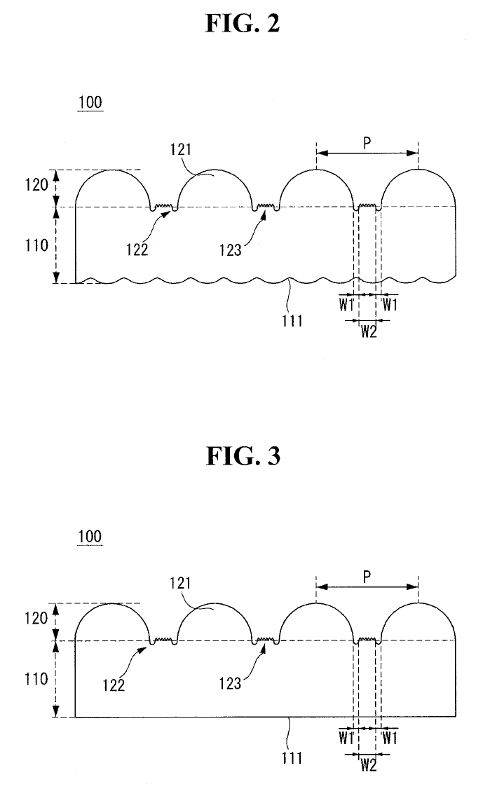

FIGS. 2 to 5 illustrate an optical film according to a first exemplary embodiment of the invention.

As shown in FIGS. 2 to 5, an optical film 100 according to a first exemplary embodiment of the invention may include a base 110 and a projection 120 on the base 110. The projection 120 may include a plurality of microlenses 121, a plurality of grooves 122 positioned around the plurality of microlenses 121, and a remaining portion 123 excluding the microlenses 121 and the grooves 122 from the projection 120.

The base 110 may support the optical film 100 and transmit light coming from a light source. The base 110 may be formed of polystyrene (PS), polyacrylate (PA), polymethylmethacrylate (PMMA), polycarbonate (PC), or polyethyleneterephthalate (PET). Other materials may be used. It may be preferable to use polycarbonates having a refractive index of 1.58 in consideration of optical application.

A lower surface 111 of the base 110 may be a curved surface. The curved surface may have a regular or irregular pattern. On the other hand, as shown in FIG. 3, the lower surface 111 of the base 110 may be a flat surface.

The projection 120 on the base 110 may focus or diffuse light. The projection 120 may be formed of polystyrene (PS), polyacrylate (PA), polymethylmethacrylate (PMMA), polycarbonate (PC), or polyethyleneterephthalate (PET). Other materials may be used. It may be preferable to use polycarbonates having a refractive index of 1.58 in consideration of optical application.

The plurality of microlenses 121 may have an embossed form of a hemispherical shape. A diffusivity, a refractive index, a focusing level, etc. of the microlenses 121 may change depending on a size and a density of the microlenses 121. Hence, a pitch P between the microlenses 121 may be approximately 25 μm to 75 μm. Diameters of the microlenses 121 may be uniform or non-uniform (i.e., the diameters may vary). Heights of the microlenses 121 may be uniform or non-uniform (i.e., the heights may vary).

The diameter of each of the microlenses 121 may be approximately 20 μm to 60 μm. The microlenses 121 may occupy 50% to 90% of a whole area of the projection 120. A difference between the heights of the microlenses 121 may be equal to or less than approximately 5 μm. Other diameters, percentages, height differences may be used.

As described above, when the microlens 121 has the embossed form of the hemispherical shape, a portion of light from the outside (for example, from a bottom of the microlens 121) may be uniformly refracted from the hemispherical surface in an azimuth direction and then be transmitted by the microlens 121. Because of this, a portion of light coming from the bottom of the microlens 121 may be uniformly diffused upward and may be focused.

An average surface roughness of each of the microlenses 121 may be approximately 0.3 μm to 1.5 μm. When the average surface roughness of the microlenses 121 is equal to or greater than 0.3 μm, a diffusion characteristic of the optical film 100 may be improved. When the average surface roughness of the microlenses 121 is equal to or less than 1.5 μm, a luminance characteristic of the optical film 100 may be improved.

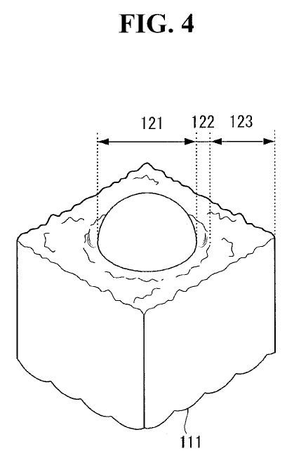

The microlens 121, the groove 122, and the remaining portion 123 of the projection 120 are described in detail with reference to FIG. 4.

As shown in FIG. 4, the grooves 122 are positioned around the microlenses 121. The grooves 122 may be formed during a fabrication of the optical film 100. An average surface roughness of each of the grooves 122 may be approximately 0.1 μm to 3 μm. A width of each of the grooves 122 may be approximately 1 μm to 5 μm. Other average surface roughnesses or widths may be used.

The remaining portion 123 may be a remaining portion excluding the microlens 121 and the groove 122 from the projection 120. The remaining portions 123 may have a uniform roughness. An average surface roughness of the remaining portions 123 may be approximately 0.1 μm to 3 μm. Other average surface roughnesses may be used.

As shown in FIGS. 2 and 3, a relationship P: 2W1+W2 between the microlenses 121, the grooves 122, and the remaining portion 123 may be approximately 25:1 to 25:15, where P is a pitch of the microlenses 121, W1 is a width of one of the grooves 122 inside the pitch P of the microlenses 121, and W2 is a width of the remaining portion 123 inside the pitch P of the microlenses 121. The pitch P is a distance between center points of the adjacent microlenses 121.

When the relationship P: 2W1+W2 is equal to or greater than 25:1, the diffusion characteristic of the optical film 100 may be improved because of an increase in a width of each of the grooves 122 and the remaining portion 123. When the relationship P: 2W1+W2 is equal to or less than 25:15, a reduction in the luminance characteristic of the optical film 100 resulting from the wide pitch P of the microlens 121 may be prevented.

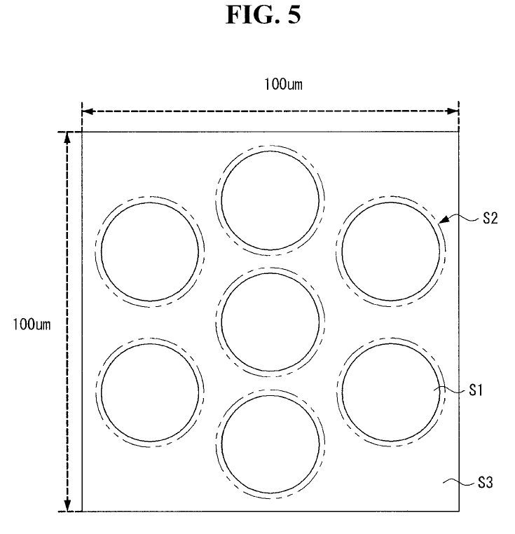

FIG. 5 is a plane view schematically illustrating an optical film having the size of 100 μm×100 μm.

As shown in FIG. 5, in the optical film 100 according to the first exemplary embodiment of the invention, a ratio S1: (S2+S3) of an area S1 of the microlenses 121 to a sum of an area S2 of the grooves 122 and an area S3 of the remaining portion 123 may be approximately 20:11 to 20:50. The ratio S1: (S2+S3) is obtained by changing the sum (S2+S3) of areas from 11 to 50 in a state where the area S1 of the microlenses 121 is fixed at 20.

When the ratio S1: (S2+S3) is equal to or greater than 20:11, the diffusion characteristic of the optical film 100 may be improved because of an increase in the area S2 of the grooves 122 and the area S3 of the remaining portion 123. When the ratio S1: (S2+S3) is equal to or less than 20:50, a reduction in the luminance characteristic of the optical film 100 resulting from the large area S2 of the grooves 122 and the large area S3 of the remaining portion 123 may be prevented.

A ratio S2:S3 of the area S2 of the grooves 122 to the area S3 of the remaining portion 123 may be approximately 1:1 to 1:6.25. When the ratio S2:S3 is equal to or greater than 1:1, the diffusion characteristic of the optical film 100 may be improved because of an increase in the area S3 of the remaining portion 123. When the ratio S2:S3 is equal to or less than 1:6.25, a reduction in the luminance characteristic of the optical film 100 resulting from the large area S3 of the remaining portion 123 may be prevented.

As described above, in the optical film 100 according to the first exemplary embodiment of the invention, the base 110 may diffuse light from the light source under the base 110, and light coming from the projection 120 may be focused and diffused. Hence, the luminance and the luminance uniformity of light may be simultaneously improved.

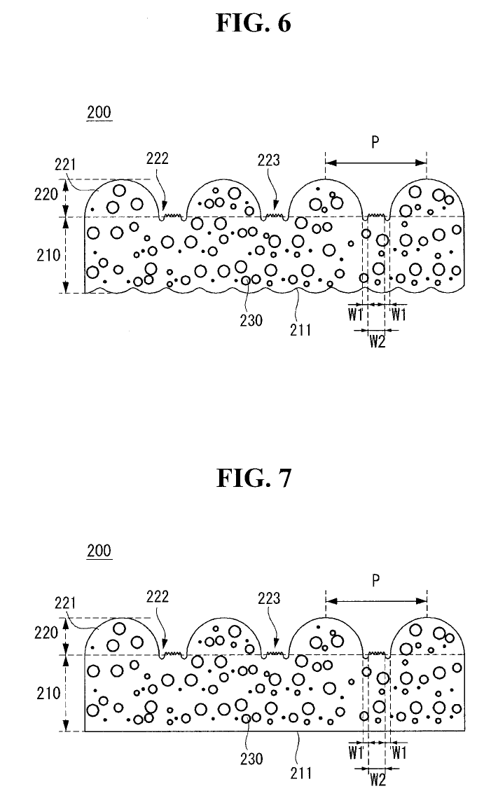

FIGS. 6 and 7 illustrate an optical film according to a second exemplary embodiment of the invention.

As shown in FIGS. 6 and 7, an optical film 200 according to a second exemplary embodiment of the invention may include a base 210 and a projection 220 on the base 210. The projection 220 may include a plurality of microlenses 221, a plurality of grooves 222 positioned around the plurality of microlenses 221, and a remaining portion 223 excluding the microlenses 221 and the grooves 222 from the projection 220.

A lower surface 211 of the base 210 may be a curved surface in the same manner as the first exemplary embodiment. The curved surface may have a regular or irregular pattern. On the other hand, as shown in FIG. 7, the lower surface 211 of the base 210 may be a flat surface.

An average surface roughness of each of the microlenses 221 may be approximately 0.3 μm to 1.5 μm. An average surface roughness of each of the grooves 222 may be approximately 0.1 μm to 3 μm. A width of each of the grooves 222 may be approximately 1 μm to 5 μm. Other average surface roughnesses or widths may be used.

In the same manner as the first exemplary embodiment, a relationship P: 2W1+W2 between the microlenses 221, the grooves 222, and the remaining portion 223 may be approximately 25:1 to 25:15, where P is a pitch of the microlenses 221, W1 is a width of one of the grooves 222 inside the pitch P of the microlenses 221, and W2 is a width of the remaining portion 223 inside the pitch P of the microlenses 221. The pitch P is a distance between center points of the adjacent microlenses 221.

Further, a ratio S1: (S2+S3) of an area S1 of the microlenses 221 to a sum of an area S2 of the grooves 222 and an area S3 of the remaining portion 223 may be approximately 20:11 to 20:50. A ratio S2:S3 of the area S2 of the grooves 222 to the area S3 of the remaining portion 223 may be approximately 1:1 to 1:6.25.

The base 210 and the projection 220 may include a plurality of diffusion particles 230. The diffusion particles 230 may be formed of at least one selected from the group consisting of silicon, polymethylmethacrylate (PMMA), and polycarbonate (PC). The diffusion particles 230 may have a diameter of approximately 1 μm to 20 μm. The diffusion particles 230 may have the uniform or nonuniform size and may be uniformly or nonuniformly distributed in each of the base 210 and the projection 220. The diffusion particles 230 may diffuse light from a light source to improve luminance uniformity.

Because the optical film 200 according to the second exemplary embodiment of the invention further includes the diffusion particles 230 unlike the optical film 100 according to the first exemplary embodiment of the invention, the diffusion characteristic of light may be further improved.

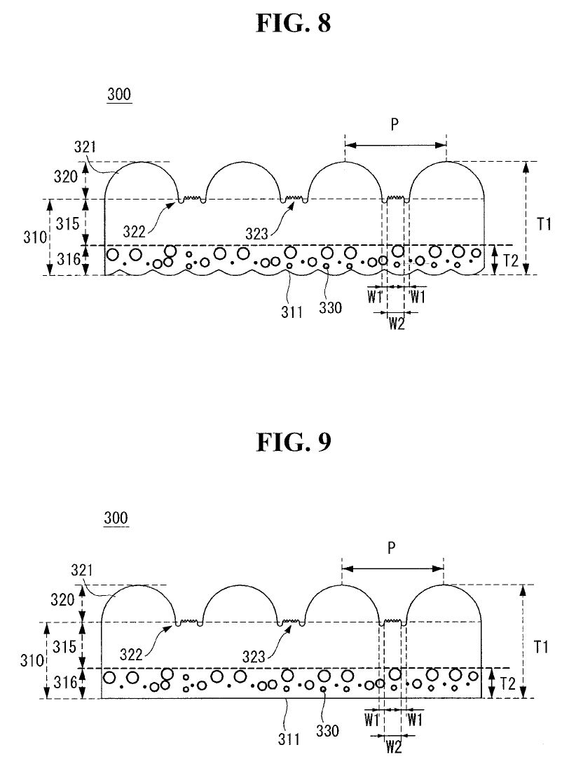

FIGS. 8 and 9 illustrate an optical film according to a third exemplary embodiment of the invention.

As shown in FIGS. 8 and 9, an optical film 300 according to a third exemplary embodiment of the invention may include a base 310 and a projection 320 on the base 310. The projection 320 may include a plurality of microlenses 321, a plurality of grooves 322 positioned around the plurality of microlenses 321, and a remaining portion 323 excluding the microlenses 321 and the grooves 322 from the projection 320. The base 310 may include a first base area 315 and a second base area 316 under the first base area 315.

The second base area 316 may include a plurality of diffusion particles 330. The diffusion particles 330 may be formed of at least one selected from the group consisting of silicon, polymethylmethacrylate (PMMA), and polycarbonate (PC). The diffusion particles 330 may have a diameter of approximately 1 μm to 20 μm. The diffusion particles 330 may have the uniform or nonuniform size and may be uniformly or nonuniformly distributed in the second base area 316. The diffusion particles 330 may diffuse light from a light source to improve luminance uniformity.

The first base area 315 and the second base area 316 may be distinguished from each other depending on whether or not the diffusion particles 330 exist. The second base area 316 may occupy an area ranging from a bottom of the base 310 to an end of a diffusion particle 330 in an uppermost portion, and the first base area 315 may occupy an area ranging from the end of the diffusion particle 330 in the uppermost portion to a top of the base 310. A ratio T2:T1 of a thickness T2 of the second base area 316 to a thickness T1 of the optical film 300 may be approximately 1:5 to 1:20.

A lower surface 311 of the base 310 may be a curved surface. The curved surface may have a regular or irregular pattern. On the other hand, as shown in FIG. 9, the lower surface 311 of the base 310 may be a flat surface.

In the same manner as the first and second exemplary embodiments, an average surface roughness of each of the microlenses 321 may be approximately 0.3 μm to 1.5 μm. An average surface roughness of each of the grooves 322 may be approximately 0.1 μm to 3 μm. A width of each of the grooves 322 may be approximately 1 μm to 5 μm. Other average surface roughnesses or widths may be used. An average surface roughness of each of the remaining portion 323 may be approximately 0.1 μm to 3 μm. Other average surface roughnesses or widths may be used.

In the same manner as the first and second exemplary embodiments, a relationship P: 2W1+W2 between the microlenses 321, the grooves 322, and the remaining portion 323 may be approximately 25:1 to 25:15, where P is a pitch of the microlenses 321, W1 is a width of one of the grooves 322 inside the pitch P of the microlenses 321, and W2 is a width of the remaining portion 323 inside the pitch P of the microlenses 321. The pitch P is a distance between center points of the adjacent microlenses 321.

Further, a ratio S1: (S2+S3) of an area S1 of the microlenses 321 to a sum of an area S2 of the grooves 322 and an area S3 of the remaining portion 323 may be approximately 20:11 to 20:50. A ratio S2:S3 of the area S2 of the grooves 322 to the area S3 of the remaining portion 323 may be approximately 1:1 to 1:6.25.

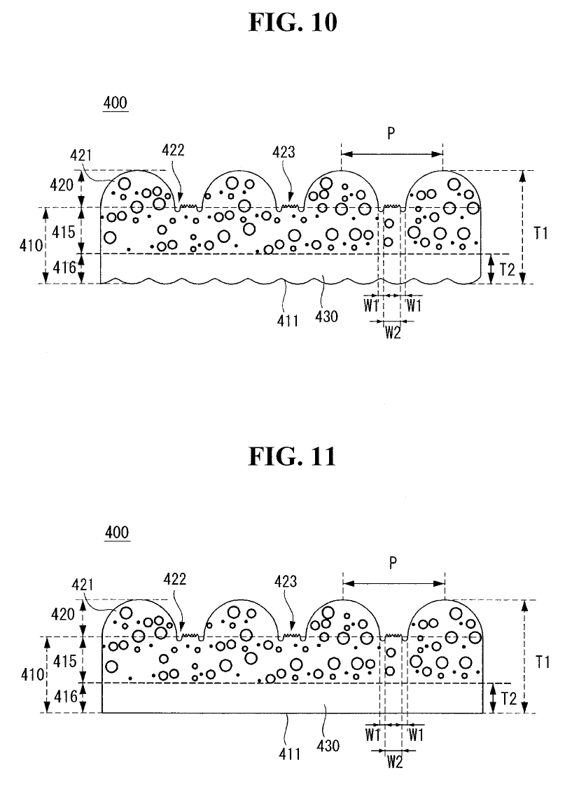

FIGS. 10 and 11 illustrate an optical film according to a fourth exemplary embodiment of the invention.

As shown in FIGS. 10 and 11, an optical film 400 according to a fourth exemplary embodiment of the invention may include a base 410 and a projection 420 on the base 410. The projection 420 may include a plurality of microlenses 421, a plurality of grooves 422 positioned around the plurality of microlenses 421, and a remaining portion 423 excluding the microlenses 421 and the grooves 422 from the projection 420. The base 410 may include a first base area 415 and a second base area 416 under the first base area 415.

The first base area 415 and the projection 420 may include a plurality of diffusion particles 430. The diffusion particles 430 may be formed of at least one selected from the group consisting of silicon, polymethylmethacrylate (PMMA), and polycarbonates (PC). The diffusion particles 430 may have a diameter of approximately 1 μm to 20 μm. The diffusion particles 430 may have the uniform or nonuniform size and may be uniformly or nonuniformly distributed in each of the first base area 415 and the projection 420. The diffusion particles 430 may diffuse light from a light source to improve luminance uniformity.

The first base area 415 and the second base area 416 may be distinguished from each other depending on whether or not the diffusion particles 430 exist. The first base area 415 may occupy an area ranging from a bottom of the projection 420 to an end of a diffusion particle 430 in a lowermost portion, and the second base area 416 may occupy an area ranging from the end of the diffusion particle 430 in the lowermost portion to a bottom of the base 410. A ratio T2:T1 of a thickness T2 of the second base area 416 to a thickness T1 of the optical film 400 may be approximately 1:5 to 1:20.

In the same manner as the first to third exemplary embodiments, a lower surface 411 of the base 410 may be a curved surface. The curved surface may have a regular or irregular pattern. On the other hand, as shown in FIG. 11, the lower surface 411 of the base 410 may be a flat surface.

An average surface roughness of each of the microlenses 421 may be approximately 0.3 μm to 1.5 μm. An average surface roughness of each of the grooves 422 may be approximately 0.1 μm to 3 μm. A width of each of the grooves 422 may be approximately 1 μm to 5 μm. Other average surface roughnesses or widths may be used. An average surface roughness of each of the remaining portion 423 may be approximately 0.1 μm to 3 μm. Other average surface roughnesses or widths may be used.

In the same manner as the first to third exemplary embodiments, a relationship P: 2W1+W2 between the microlenses 421, the grooves 422, and the remaining portion 423 may be approximately 25:1 to 25:15, where P is a pitch of the microlenses 421, W1 is a width of one of the grooves 422 inside the pitch P of the microlenses 421, and W2 is a width of the remaining portion 423 inside the pitch P of the microlenses 421. The pitch P is a distance between center points of the adjacent microlenses 421.

Further, a ratio S1: (S2+S3) of an area S1 of the microlenses 421 to a sum of an area S2 of the grooves 422 and an area S3 of the remaining portion 423 may be approximately 20:11 to 20:50. A ratio S2:S3 of the area S2 of the grooves 422 to the area S3 of the remaining portion 423 maybe approximately 1:1 to 1:6.25.

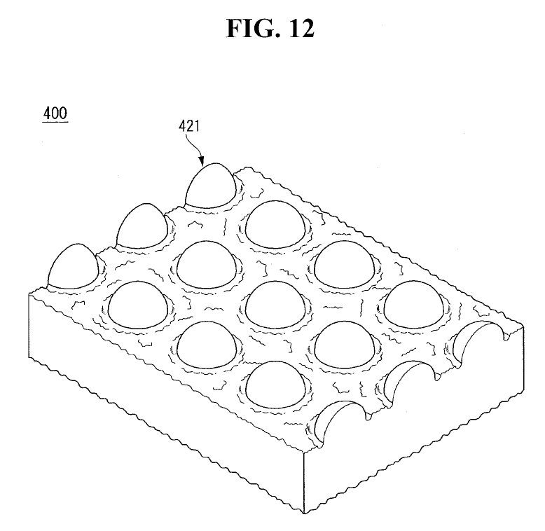

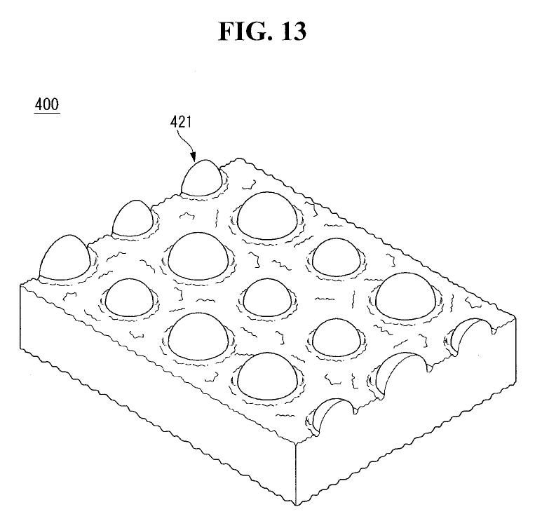

As shown in FIGS. 12 and 13, the microlenses 421 may have the uniform or nonuniform size. Other sizes may be used.

An experimental example measuring the diffusion and luminance characteristics according to the ratio P: 2W1+W2 is described below. The following experimental example may be embodied in many different forms in the embodiments of the invention. Other experimental examples may be used.

### EXPERIMENTAL EXAMPLE

First resin pellets containing polycarbonates resin and an additive were provided to a first extruder, and second resin pellets containing polycarbonates resin were provided to a second extruder. Hence, the first and second pellets were coextruded.

The first and second pellets were extruded using a first roll having a flat surface and a second roll having a reversed shape of a microlens. 11 samples of an optical film were manufactured by changing a width W1 of each of grooves positioned around microlenses and a width W2 of a remaining portion in a state a pitch P of the microlenses was fixed at 25 μm. More specifically, the 11 samples were manufactured by changing a value of (2W1+W2) to 0.6, 1, 2, 4, 6, 8, 10, 12, 14, 15, and 16 in a state the pitch P of the microlenses was fixed at 25 μm.

Table 1 indicates a result evaluating diffusion and luminance characteristics of the 11 samples. In the following Table 1, ×, ∘, and represent bad, good, and excellent states of the characteristics, respectively.

TABLE 1

| | Diffusion | Luminance |
|---|---|---|
| P:2W1 + W2 | characteristic | characteristic |
| 25:0.6 | X | X |
| 25:1 | ◯ | ◯ |
| 25:2 | ◯ | ◯ |
| 25:4 | ◯ | ◯ |
| 25:6 | ⊚ | ◯ |
| 25:8 | ⊚ | ◯ |
| 25:10 | ⊚ | ◯ |
| 25:12 | ⊚ | ◯ |
| 25:14 | ◯ | ◯ |
| 25:15 | ◯ | ◯ |
| 25:16 | ◯ | X |

As indicated in Table 1, when a ratio P: 2W1+W2 was equal to or greater than 25:1, the diffusion characteristic of the optical film may be improved. When a ratio P: 2W1+W2 exceeded 25:15, the luminance characteristic of the optical film may be reduced. When the ratio P: 2W1+W2 was 25:6 to 25:12, the diffusion characteristic of the optical film may be further improved.

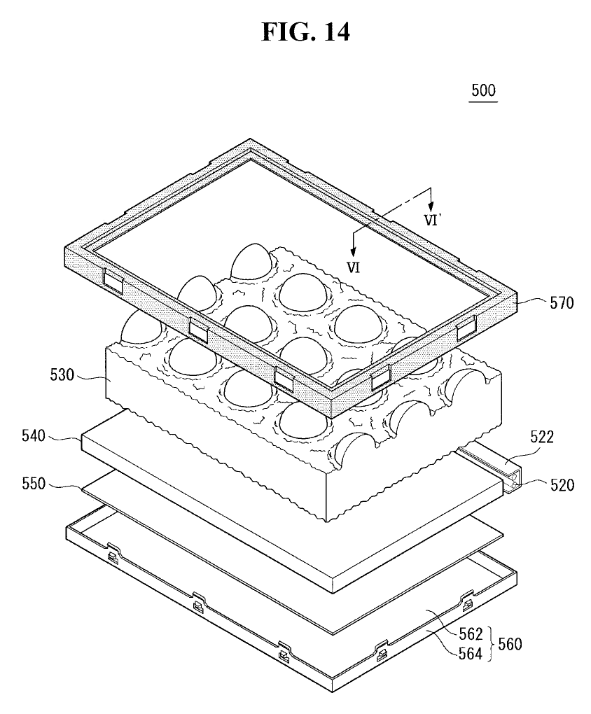

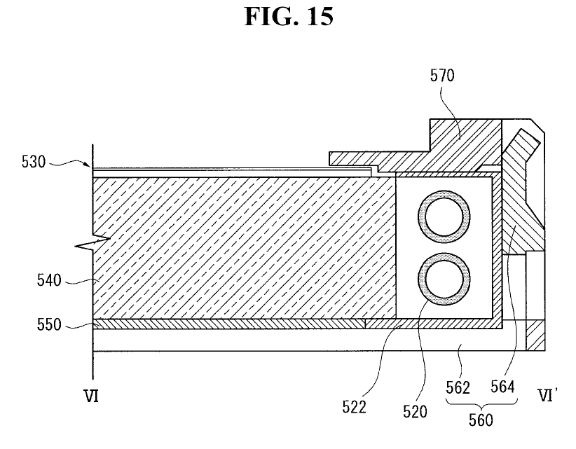

FIGS. 14 and 15 are an exploded perspective view and a cross-sectional view illustrating a configuration of a backlight unit according to an exemplary embodiment of the invention.

FIG. 14 shows an edge type backlight unit including the optical film according to the exemplary embodiments of the invention. Since the optical film according to the exemplary embodiments of the invention is described above, a further description may be briefly made or may be entirely omitted.

As shown in FIGS. 14 and 15, a backlight unit 500 according to an exemplary embodiment of the invention may be included in a liquid crystal display and may provide light to a liquid crystal display panel included in the liquid crystal display.

The backlight unit 500 may include a light source 520 and an optical film 530. The backlight unit 500 may further include a light guide 540 (or light guide plate), a reflector 550 (or reflector plate), a bottom cover 560, and a mold frame 570.

The light source 520 may produce light using a driving power received from outside and may emit the produced light.

The light source 520 may be positioned at one side of the light guide 540 along a long axis direction of the light guide 540. The light source 520 may be positioned at both sides of the light guide 540. Light from the light source 520 may be directly incident on the light guide 540. Alternatively, the light from the light source 520 may be reflected by a light source housing 522 surrounding a portion of the light source 520, for example, surrounding about ¾ of an outer circumferential surface of the light source 520, and then the light may be incident on the light guide 540.

The light source 520 may be one of a cold cathode fluorescent lamp (CCFL), a hot cathode fluorescent lamp (HCFL), an external electrode fluorescent lamp (EEFL), and a light emitting diode (LED). Other light sources may also be used.

The optical film 530 may be positioned on the light guide 540. The optical film 530 may focus the light from the light source 520.

The optical film according to the exemplary embodiments of the invention includes a base and a projection including a plurality of microlenses and a plurality of grooves positioned around the plurality of microlenses. Although it is not shown, the optical film may include a prism sheet or a protective sheet.

The light guide 540 may face the light source 520. The light guide 540 may guide the light so as to emit the light from the light source 520 in an upward manner.

The reflector 550 may be positioned under the light guide 540. The reflector 550 may reflect the light upward. The light may come from the light source 520 and then may be emitted downward via the light guide 540.

The bottom cover 560 may include a bottom portion 562 and a side portion 564 extending from the bottom portion 562 to form a recipient space. The recipient space may receive the light source 520, the optical film 530, the light guide 540, and the reflector 550.

The mold frame 570 may be an approximately rectangular-shaped frame. The mold frame 570 may be fastened to the bottom cover 560 from an upper side of the bottom cover 560 in a top-down manner.

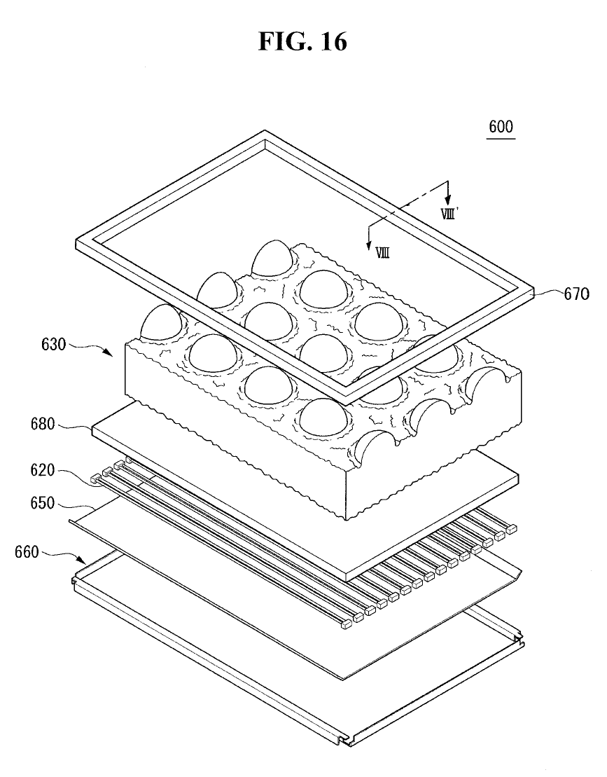

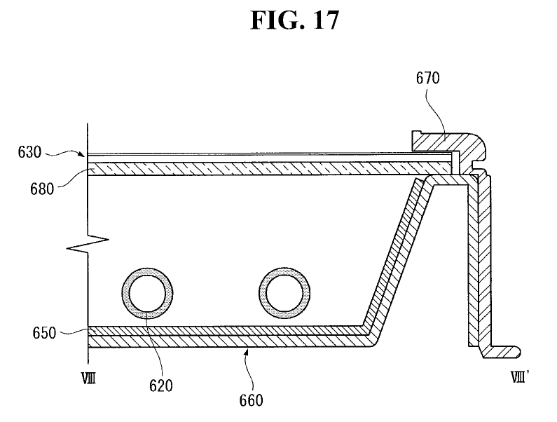

FIGS. 16 and 17 are an exploded perspective view and a cross-sectional view illustrating another configuration of a backlight unit according to an embodiment of the invention.

FIGS. 16 and 17 show a direct type backlight unit. Since a backlight unit shown in FIGS. 16 and 17 may be substantially the same as the backlight unit shown in FIGS. 14 and 15 (except a location of a light source and changes in components depending on location of the light source), a further description may be briefly made or may be entirely omitted.

As shown in FIGS. 16 and 17, a backlight unit 600 according to an embodiment of the invention may be included in a liquid crystal display and may provide light to a liquid crystal display panel included in the liquid crystal display.

The backlight unit 600 may include a light source 620 and an optical film 630. The backlight unit 600 may further include a reflector 650 (or reflector plate), a bottom cover 660, a mold frame 670, and a diffusion plate 680 (or diffuser).

The light source 620 may be positioned under the diffusion plate 680. Therefore, light from the light source 620 may be directly incident on the diffusion plate 680.

The optical film 630 may be positioned on the diffusion plate 680. The optical film 630 may focus the light from the light source 620.

The optical film according to the exemplary embodiments of the invention includes a base and a projection including a plurality of microlenses and a plurality of grooves positioned around the plurality of microlenses. Although it is not shown, the optical film may include a prism sheet or a protective sheet.

The diffusion plate 680 may be positioned between the light source 620 and the optical film 630 and may diffuse the light from the light source 620 in an upward manner. A shape of the light source 620 underlying the diffusion plate 680 may not be seen from a top of the backlight unit 600 because of the diffusion plate 680. The diffusion plate 680 may further diffuse the light from the light source 620.

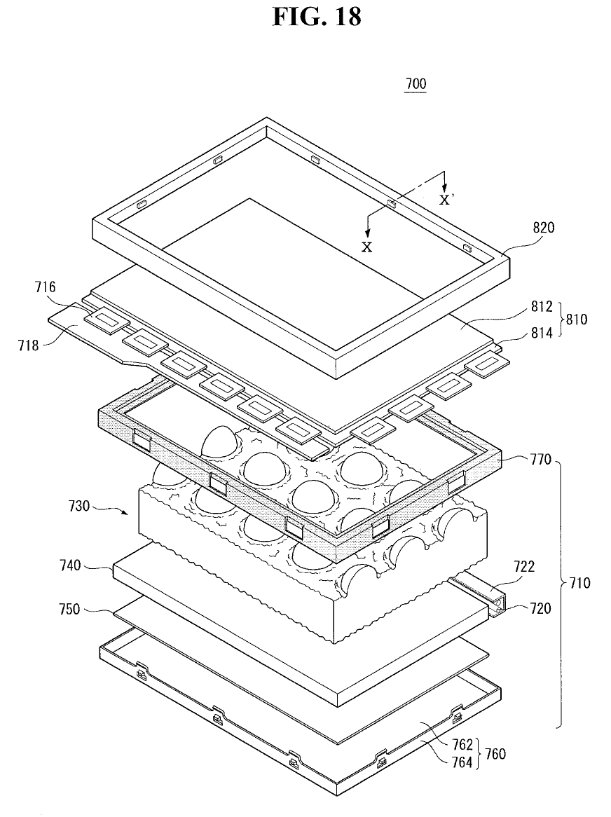

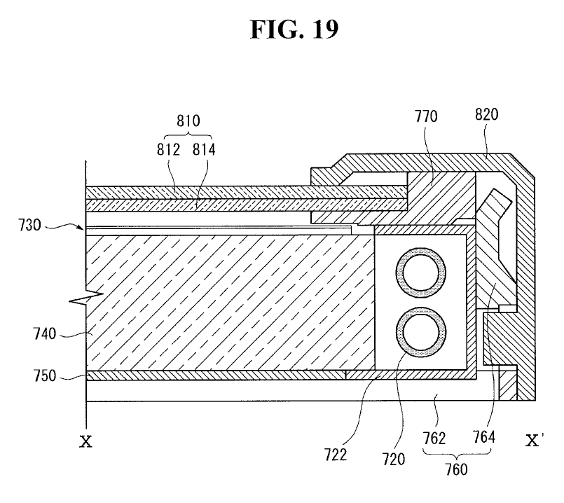

FIGS. 18 and 19 are an exploded perspective view and a cross-sectional view illustrating a configuration of a liquid crystal display according to an exemplary embodiment of the invention. FIGS. 18 and 19 show a liquid crystal display including the backlight unit shown in FIGS. 14 and 15. However, the liquid crystal display shown in FIGS. 18 and 19 may include the backlight unit shown in FIGS. 16 and 17. Since the backlight unit shown in FIGS. 18 and 19 is described above with reference to FIGS. 14 and 15, a further description thereof will be briefly made or will be entirely omitted.

As shown in FIGS. 18 and 19, a liquid crystal display 700 according to an exemplary embodiment of the invention may display an image using electro-optical characteristics of liquid crystals.

The liquid crystal display 700 may include the backlight unit 710 and a liquid crystal display panel 810.

The backlight unit 710 may be positioned under the liquid crystal display panel 810 and may provide light to the liquid crystal display panel 810. The backlight unit 710 may include a light source 720 and an optical film 730. The backlight unit 710 may further include a light guide 740 (or light guide plate), a reflector 750 (or reflector plate), a bottom cover 760, and a mold frame 770.

The liquid crystal display panel 810 may be positioned on the mold frame 770. The liquid crystal display panel 810 may be fixed by a top cover 820 that is fastened to the bottom cover 760 in a top-down manner.

The liquid crystal display panel 810 may display an image using light provided by the light source 720 of the backlight unit 710.

The liquid crystal display panel 810 may include a color filter substrate 812 and a thin film transistor substrate 814 that are opposite to each other with liquid crystals interposed between the color filter substrate 812 and the thin film transistor substrate 814.

The color filter substrate 812 may achieve colors of an image displayed on the liquid crystal display panel 810.

The color filter substrate 812 may include a color filter array of a thin film form on a substrate made of a transparent material, such as glass or plastic. For example, the color filter substrate 812 may include red, green, and blue color filters. An upper polarizing plate may be positioned on the color filter substrate 812.

The thin film transistor substrate 814 may be electrically connected to a printed circuit board 718, on which a plurality of circuit parts are mounted, through a driving film 716. The thin film transistor substrate 814 may apply a driving voltage received from the printed circuit board 718 to the liquid crystals in response to a driving signal received from the printed circuit board 718.

The thin film transistor substrate 814 may include a thin film transistor and a pixel electrode on another substrate formed of a transparent material, such as glass or plastic. A lower polarizing plate may be positioned under the thin film transistor substrate 814.

As described above, because the optical film according to the exemplary embodiments of the invention is manufactured using an extruding method, mass production is possible and production yield may increase.

Furthermore, because the optical film according to the exemplary embodiments of the invention includes the base having the curved surface and the projection, the optical film can efficiently focus light. Accordingly, the luminance of light can be improved.

Furthermore, because the optical film according to the exemplary embodiments of the invention includes the diffusion particles, the bright line in which a luminance of a portion, in which a light source is positioned under the portion, is greater than other portions, can be prevented. Accordingly, the reliability of the optical film can be improved.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An optical film comprising:
a base; and
a projection including a plurality of microlenses and a plurality of grooves positioned around the plurality of microlenses.

2. The optical film of claim 1, wherein the base or the projection includes a plurality of diffusion particles.

3. The optical film of claim 1, wherein the base includes a first base area and a second base area positioned under the first base area,
wherein the second base area includes a plurality of diffusion particles.

4. The optical film of claim 1, wherein the base includes a first base area and a second base area positioned under the first base area,
wherein each of the first base area and the projection includes a plurality of diffusion particles.

5. The optical film of claim 1, wherein the base includes a first base area and a second base area positioned under the first base area, and
wherein a thickness ratio of the second base area and the optical film is approximately 1:5 to 1:20.

6. The optical film of claim 1, wherein the base and the projection form an integral body and are formed of the substantially same material.

7. The optical film of claim 1, wherein an average surface roughness of at least one of the microlenses is approximately 0.3 μm to 1.5 μm.

8. The optical film of claim 1, wherein an average surface roughness of at least one of the grooves is approximately 0.1 μm to 3 μm.

9. The optical film of claim 1, wherein the projection further includes a remaining portion excluding the microlenses and the grooves from the projection.

10. The optical film of claim 9, wherein an average surface roughness of the remaining portion is approximately 0.1 μm to 3 μm.

11. The optical film of claim 1, wherein a lower surface of the base is an uneven surface.

12. The optical film of claim 11, wherein an average surface roughness of the lower surface of the base is approximately 1 μm to 5 μm.

13. The optical film of claim 1, wherein a diameter of at least one of the microlenses is approximately 20 μm to 60 μm.

14. The optical film of claim 1, wherein a pitch of the microlenses is approximately 25 μm to 75 μm, the pitch being a distance between center points of the adjacent microlenses.

15. The optical film of claim 1, wherein a height difference between the microlenses is equal to or less than approximately 5 μm.

16. The optical film of claim 9, wherein a ratio of an area of the microlenses to a sum of an area of the grooves and an area of the remaining portion is approximately 20:11 to 20:50.

17. The optical film of claim 9, wherein a ratio of an area of the grooves to an area of the remaining portion is approximately 1:1 to 1:6.25.

18. The optical film of claim 14, wherein a relationship P: 2W1+W2 between the microlenses, the grooves, and the remaining portion is approximately 25:1 to 25:15, where P is a pitch of the microlenses, W1 is a width of one of the grooves inside the pitch P of the microlenses, and W2 is a width of the remaining portion inside the pitch P of the microlenses.

19. A back light unit comprising:
a light source; and
an optical film on the light source, the optical film including:
a base; and
a projection including a plurality of microlenses, a plurality of grooves positioned around the plurality of microlenses, and a remaining portion excluding the microlenses and the grooves from the projection,
wherein a relationship P: 2W1+W2 between the microlenses, the grooves, and the remaining portion is approximately 25:1 to 25:15, where P is a pitch of the microlenses, W1 is a width of one of the grooves inside the pitch P of the microlenses, and W2 is a width of the remaining portion inside the pitch P of the microlenses.

20. A liquid crystal display comprising:
a light source;
an optical film on the light source, the optical film including:
a base, and
a projection including a plurality of microlenses, a plurality of grooves positioned around the plurality of microlenses, and a remaining portion excluding the microlenses and the grooves from the projection,
wherein a relationship P: 2W1+W2 between the microlenses, the grooves, and the remaining portion is approximately 25:1 to 25:15, where P is a pitch of the microlenses, W1 is a width of one of the grooves inside the pitch P of the microlenses, and W2 is a width of the remaining portion inside the pitch P of the microlenses; and
a liquid crystal display panel on the optical film.
